(19) United States
(12) Patent Application Publication
(10) Pub. No.: US 2024/0148033 A1
(43) Pub. Date: May 9, 2024

(54) METHOD FOR MANUFACTURING KKAKDUGI FRIED RICE

(71) Applicant: Homsrang Agricultural Corporation, Gangwon-do (KR)

(72) Inventor: Hyeokseung Yoon, Gangwon-do (KR)

(73) Assignee: Homsrang Agricultural Corporation, Gangwon-do (KR)

(21) Appl. No.: 17/985,916

(22) Filed: Nov. 14, 2022

(30) Foreign Application Priority Data
Nov. 9, 2022 (KR) 10-2022-0149045

(51) Int. Cl. A23L 7/196; A23L 5/10; A23L 19/00

(52) U.S. Cl. CPC A23L 7/1965; A23L 5/11; A23L 5/13; A23L 19/03; A23V 2002/00

(57) ABSTRACT

The method for manufacturing Kkakdugi fried rice according to the embodiments of the present invention comprises a washing stage of washing prepared mixed rice; a first preparation stage of chopping vegetables; a rice-cooking stage of mixing the washed mixed rice with rice-cooking water to perform rice-cooking; a second preparation stage of cutting prepared Kkakdugi in a predetermined form and cooking the cut Kkakdugi through a steaming process with steam and then aging same; and a cooking stage of heating and mixing the cooked mixed rice with chopped vegetables, aged Kkakdugi, subsidiary ingredients and oils through a stirring process to cook fried rice.

### CROSS-REFERENCE TO RELATED APPLICATIONS

This application claims the priority of Korean Patent Application No. 10-2022-0149045 filed on Nov. 9, 2022, in the Korean Intellectual Property Office, the disclosure of which is incorporated herein by reference.

### BACKGROUND OF THE INVENTION

### Field of the Invention

The present invention relates to fried rice, and, in more detail, a method for manufacturing Kkakdugi fried rice.

### Description of the Related Art

Kkakdugi is a type of Kimchi made by cutting radish into square cubes, salting it, and mixing it with red pepper powder or other seasonings.

Such Kkakdugi is a unique fermented food essential for Koreans' tables, and has been used as a complex food that goes best with rice, the staple food, and is closely related to Koreans' diet.

Currently, such Kkakdugi is used as the main ingredient for fried rice stir-fried in an oil while mixing ingredients such as rice, chopped meat and various vegetables. One may feel unique taste and aroma of the added ingredients depending on what ingredients are added to fried rice and may also ingest the unique nutrients of the added ingredients together. Since the cooking method is simple, various types of fried rice with various ingredients are widely known.

Recently, as the number of people living alone increases, such fried rice is being used as a good menu for them since it may be easily made and Kkakdugi described above may be added to it to offset the greasy feeling of fried rice and consume the leftover Kkakdugi stored in the refrigerator for a long time. In addition to kkakdugi, other ingredients such as sesame, seasoned vegetables, carrots, potatoes, onions and peas are stir-fried and put together to make fried rice in a variety of recipes to suit people's tastes and sell it on the market.

However, fried rice sold on the market is made by mixing a large amount of cheap ingredients and using a general recipe and, thus, has problems that the ingredients are not evenly mixed and the taste is not harmonious to reduce the flavor of fried rice.

Accordingly, there is a need to develop fried rice to satisfy the various preferences of consumers living alone and consumers with improved living standards.

### SUMMARY OF THE INVENTION

The embodiments of the present invention have been proposed to solve the problems described above and aim to provide a method for manufacturing Kkakdugi fried rice with the unique texture of Kkakdugi, a flavor suitable for modern people's tastes and excellent nutrition.

The objective of the present invention is not limited to that described above, and other objectives not described above will be clearly understood by those skilled in the art from the following detailed description.

The method for manufacturing Kkakdugi fried rice according to the embodiments of the present invention comprises a washing stage of washing prepared mixed rice; a first preparation stage of chopping vegetables; a rice-cooking stage of mixing the washed mixed rice with rice-cooking water to perform rice-cooking; a second preparation stage of cutting prepared Kkakdugi in a predetermined form and cooking the cut Kkakdugi through a steaming process with steam and then aging same; and a cooking stage of heating and mixing the cooked mixed rice with chopped vegetables, aged Kkakdugi, subsidiary ingredients and oils through a stirring process to cook fried rice.

In addition, the mixed rice may comprise white rice, brown rice and black rice in a weight ratio of 1:0.1 to 0.3:0.3 to 0.5.

In addition, in the first preparation stage, the vegetables comprise 30 to 50 wt % of potatoes, 20 to 40 wt % of carrots and 20 to 40 wt % of shiitake mushrooms, based on 100 wt % of the vegetables.

In addition, in the cooking stage, the fried rice may comprise 40 to 60 wt % of washed mixed rice, 20 to 40 wt % of aged Kkakdugi, 7 to 13 wt % of chopped vegetables, 6.1 to 11.5 wt % of subsidiary ingredients, and 0.6 to 4.5 wt % of oils, based on 100 wt % of the fried rice.

In addition, the subsidiary ingredients comprise fried confectionery, pollack roe and purified water in a weight ratio of 1:6:10.

In addition, the oils may comprise sunflower seed oil, perilla oil and sesame oil in a weight ratio of 1:1:1.

In addition, after the cooking stage, a shipping stage of dividing the cooked fried rice in a predetermined weight and then packaging it is added.

The method for manufacturing Kkakdugi fried rice according to the embodiments of the present invention produces the effect of providing the unique texture of Kkakdugi, a flavor suitable for modern people's tastes and excellent nutrition.

The effects of the present invention are not limited to those described above, and other effects not described above will be clearly understood by those skilled in the art from the description of the claims.

### BRIEF DESCRIPTION OF THE DRAWINGS

FIG. 1 is a flowchart illustrating a method for manufacturing Kkakdugi fried rice according to the embodiments of the present invention.

FIG. 2A is an exploded view of a device for steaming Kkakdugi.

FIG. 2B is a completed assembly diagram of a device for steaming Kkakdugi.

FIG. 3 is a flowchart illustrating a cooking stage in a method for manufacturing Kkakdugi fried rice according to the embodiments of the present invention.

FIG. 4 is a flowchart illustrating a shipping stage in a method for manufacturing Kkakdugi fried rice according to the embodiments of the present invention.

### DETAILED DESCRIPTION OF THE INVENTION

Other advantages and features of the present invention and a method for achieving them will become clear with reference to the embodiments to be described below in detail together with the attached drawings. However, the present invention is not limited to those described below and may be implemented in various forms. The embodiments are provided herein to complete the description of the present invention and fully inform those skilled in the art of the scope of the present invention. The present invention is only defined by the scope of the claims.

Even if not defined, all terms (including technical or scientific terms) used herein have the same meaning as those generally accepted by universal technology in the technical field to which the present invention belongs. The terms defined by general dictionaries may be construed as having the same meaning as the relevant technology and/or the specification of the present application and will not be conceptualized or interpreted overly formal, even if not clearly defined herein.

Hereinafter, the detailed embodiments of the present invention will be described in detail with reference to the drawings.

In addition, in describing the present invention, if it is determined that a detailed description of a related known configuration or function may obscure the gist of the present invention, the detailed description thereof will be omitted.

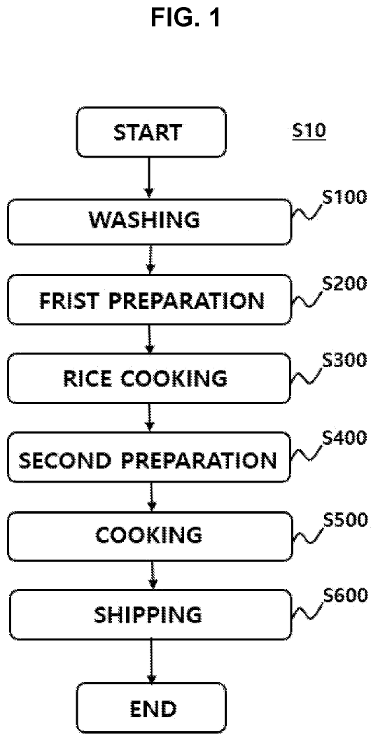

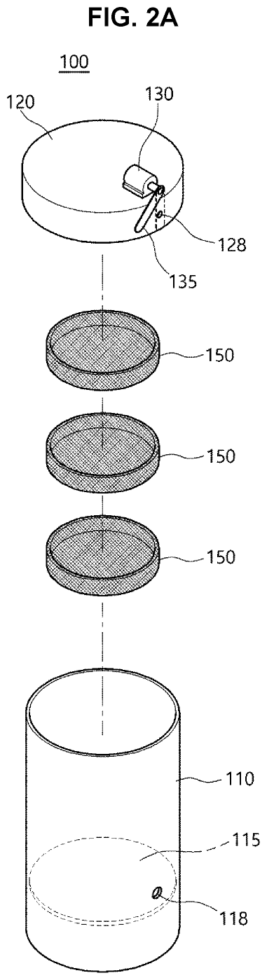

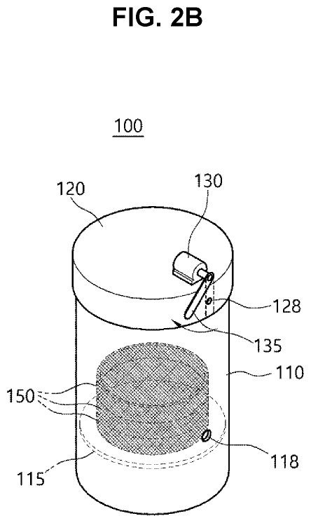

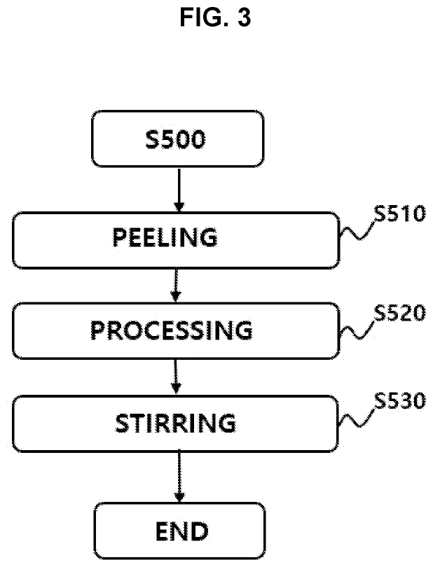

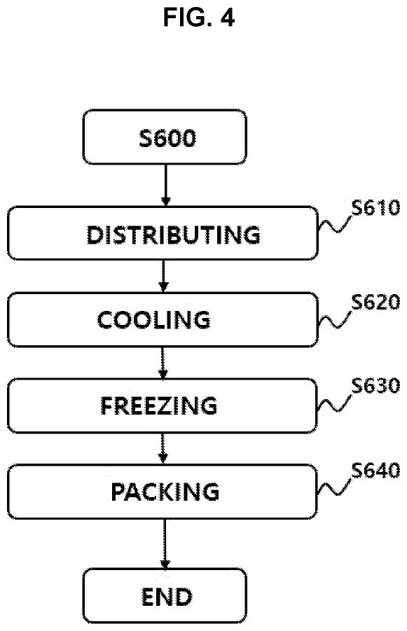

FIG. 1 is a flowchart illustrating a method for manufacturing Kkakdugi fried rice according to the embodiments of the present invention, and FIGS. 2A and 2B are diagrams illustrating a steaming process using a device for steaming Kkakdugi in a method for manufacturing Kkakdugi fried rice according to the embodiments of the present invention, and FIG. 3 is a flowchart illustrating a cooking stage in a method for manufacturing Kkakdugi fried rice according to the embodiments of the present invention, and FIG. 4 is a flowchart illustrating a shipping stage in a method for manufacturing Kkakdugi fried rice according to the embodiments of the present invention.

Referring to FIG. 1, a method for manufacturing Kkakdugi fried rice (S10) according to the embodiments of the present invention comprises a washing stage (S100) of washing prepared mixed rice, a first preparation stage (S200) of chopping vegetables, a rice-cooking stage (S300) of mixing the washed mixed rice with rice-cooking water to perform rice-cooking, a second preparation stage (S400) of cutting prepared Kkakdugi in a predetermined form and cooking the cut Kkakdugi through a steaming process with steam and then aging same, and a cooking stage (S500) of heating and mixing the cooked mixed rice with chopped vegetables, aged Kkakdugi, subsidiary ingredients and oils through a stirring process to cook fried rice.

The washing stage (S100) is the step of washing prepared mixed rice in purified water, comprising immersing prepared mixed rice in purified water for 8 to 10 hours and then stirring same for 2 to 3 hours using a stirrer.

Here, the mixed rice may comprise a mixture of white rice and brown rice or a mixture of white rice and black rice, and using all of white rice, brown rice, and black rice together is preferred in terms of health. In addition, when using all of white rice, brown rice and black rice, the mixed rice preferably comprises 100 parts by weight of white rice, 10 to 30 parts by weight of brown rice and 30 to 50 parts by weight of black rice.

In addition, the first preparation stage (S200) is the step of cutting vegetables into edible sizes and then processing them to make them rich in texture.

Here, the vegetables may comprise 30 to 50 wt % of potatoes, 20 to 40 wt % of carrots and 20 to 40 wt % of shiitake mushrooms, based on 100 wt % of the vegetables.

In addition, the first preparation stage (S200) further comprises a frying stage of frying chopped vegetables in olive oil.

In the frying stage, it is preferred to sequentially fry vegetables such as potatoes, carrots and shiitake mushrooms by frying potatoes and carrots first and then adding and frying shiitake mushrooms, thereby providing the visibility and crunchy texture of vegetables at the same time.

In addition, the rice-cooking stage (S300) is the step of cooking flavorful rice, wherein the washed mixed rice is mixed with rice-cooking water, and the rice-cooking water is used in a pre-seasoned state.

The rice-cooking water and washed mixed rice are mixed at an appropriate ratio for cooking delicious rice to perform a rice-cooking process using a rice-cooking device. Such rice-cooking process may comprise continuously transferring the mixture of the rice-cooking water and washed mixed rice and heating same to make rice, letting same settle in its own heat, and cooling same at room temperature.

Here, it is preferred to heat a mixture of dried kelp, dried pollack, dried shrimp, dried onions, dried garlic, dried green onions and water at 100 to 120° C. for 1 to 2 hours to make rice-cooking water.

In addition, the second preparation stage (S400) comprises cutting prepared Kkakdugi into an easy-to-eat size and changing Kkakdugi having a hard texture to have a soft texture on the outside and a hard texture on the inside.

Specifically, in the cutting step of the second preparation stage (S400), the prepared Kkakdugi may be cut in a predetermined form, and the predetermined form may be a cube or a rectangular parallelepiped having a thickness of 2 to 4 mm.

At this time, the prepared Kkakdugi is cut at a pressure of 80 to 140 kgf/cm² with a cutter in order not to deform the shape of the prepared Kkakdugi such that Kkakdugi is evenly shaped and has accurately uniform surfaces.

Thereafter, a steaming process with steam is performed on the cut Kkakdugi using a device for steaming Kkakdugi (100).

The steaming process using the device for steaming Kkakdugi (100) may involve steam at 100° C. to 120° C. and be performed for 1 to 5 minutes.

Accordingly, the Kkakdugi cooked through the steaming process has a soft tissue layer with a soft texture on the surface due to high temperature steam and a tissue having a hard tissue layer with a hard texture in the center, thereby making it easy to chew and providing a crunchy texture using the internal hard tissue layer such that even people with weak teeth or poor digestion may eat it comfortably with sufficient chewing feeling.

Meanwhile, the step of adding kimchi lactobacillus to the Kkakdugi cut to the predetermined size and subjected to the steaming process is performed.

The sour taste of Kkakdugi formed depending on the taste or degree of being cooked may keep constant by the addition of such kimchi lactobacillus.

Next, the cooked Kkakdugi is immersed in a seasoning solution and aged for 2 to 3 hours.

Here, the seasoning solution preferably comprises glycine, saline, red pepper powder, dental pigment, sodium L-glutamic acid, saccharin and purified water.

Hereinafter, the step of cooking Kkakdugi using a device for steaming Kkakdugi in the second preparation stage (S400) will be described in detail with reference to FIGS. 2A and 2B.

FIG. 2A is an exploded view of the device for steaming Kkakdugi, and FIG. 2B is a completed assembly diagram of the device for steaming Kkakdugi.

Referring to FIGS. 2A and 2B, the device for steaming Kkakdugi (100) comprises a partition wall part (115) that allows the internal accommodation space to be divided vertically into an upper storage part (112) and a lower storage part (114), a drum-shaped steaming case (110) with an open upper part, and a cover part (120) that opens and closes the upper part of the steaming case (110).

In addition, the device may comprise a frame for housing Kkakdugi (140) installed inside the upper storage part (1122) of the partition wall part (115), and the partition wall part (115) comprises a through hole (118) that is a passageway to supply water to the lower storage part (114) and discharges steam generated from the heated water back to the upper part.

In addition, the frame for housing Kkakdugi (140) is in the form of a drum having an open upper part and specifically in the form of a mesh net to accommodate the Kkakdugi cut to a certain thickness, thereby allowing external steam to enter thereinto.

In addition, a plurality of the frames for housing Kkakdugi (140) may be vertically stacked. As a result, by using a plurality of the frames for housing Kkakdugi (140), the surfaces of Kkakdugi having a predetermined distance and arranged at a certain height in the frames for housing Kkakdugi (140) contact with steam at a high temperature to produce the effect of steaming them evenly. Although not shown in detail, it is preferred that an indication unit to indicate the height of the Kkakdugi stack is contained inside of each of the frames for housing Kkakdugi (140), or different colors are applied to the upper and lower parts of the side of the frame for housing Kkakdugi (140) up to a predetermined height to accommodate the Kkakdugi up to a certain height, thereby achieving the effect of steaming the Kkakdugi evenly.

Meanwhile, the cover part (120) comprises an opening hole (128), a motor part (130) is installed on the upper part of the cover part (120), and the rotating shaft of the motor part (130) comprises an opening/closing blade (135) for opening and closing the opening hole (128) while rotating.

Therefore, using opening and closing of the opening hole (128) through rotation of the opening/closing blade (135) prevents excessive pressure or temperature increase of the inside of the device for steaming Kkakdugi (100).

Referring to FIG. 3, the cooking stage (S500) comprises a stirring stage (S530) of spreading a main ingredient, subsidiary ingredients and oils evenly on a heated plate and stirring them for 2 to 3 hours through a stirrer.

In the cooking stage (S500), the fried rice may comprise 40 to 60 wt % of washed mixed rice, 20 to 40 wt % of aged Kkakdugi, 7 to 13 wt % of chopped vegetables, 6.1 to 11.5 wt % of subsidiary ingredients and 0.6 to 4.5 wt % of oils.

In addition, the subsidiary ingredients preferably comprise fried confectionery, pollack roe and purified water, and the fried confectionery, pollack roe and purified water are preferably employed in the weight ratio of 1:6:10.

Here, the fried confectionery may be made by performing the step of manufacturing a molded dough made by mixing a mixture of flour, sunflower oil, oleoresin rosemary, sugar, starch syrup, stir-fried somaek powder, egg white solution, D-consol, processed milk and refined salt with water and sprinkling nuts on the dough, and the step of frying the manufactured molded dough in an oil.

When it is added as a subsidiary ingredient, the fried confectionery may neutralize the excessive salty taste of the fried rice and add its crispy texture to the fried rice, thereby enriching the flavor of the fried rice. Such fried confectionery may comprise a commercially merchandized product containing the same ingredients as described above, such as a snack under the product name of “Matdongsan,” ground into a predetermined amount.

In addition, the cooking stage (S500) further comprises the peeling stage (S510) of removing the peel of the pollack roe before carrying out the stirring stage (S530) and the processing stage (S520) of cooking the pollack roe by heating for 5 minutes.

By performing such stages, it is possible to prevent the pollack roe from providing a bitter taste and a fishy taste before being added to fried rice and maintain the shape of the pollack roe during the stirring process after it is added to fried rice to prevent the deterioration of the texture and flavor of the fried rice. Also, using cooked pollack roe prevents the pollack roe from spoiling and increases the storage time at room temperature.

In addition, in the cooking stage (S500), the oils may comprise sunflower seed oil, perilla oil and sesame oil, and, specifically, the sunflower seed oil, perilla oil and sesame oil are employed in the weight ratio of 1:1:1.

Next, referring to FIG. 4, the method for manufacturing Kkakdugi fried rice (S10) according to the embodiments of the present invention may further comprise a shipping stage (S600) of dividing the cooked fried rice in a predetermined weight and then packaging same after the cooking stage (S500).

More specifically, the shipping stage (S600) comprises a distribution stage (S610) of putting the cooked fried rice in multiple containers in a predetermined weight of 200 to 400 g, a cooling stage (S612) of cooling the fried rice to decrease the temperature to 40° C. or below using an air blower, a freezing stage (S613) of freezing the cooled fried rice twice at minus 23° C. using a freezing machine, and then a packaging stage (S614) of sealing and packaging the container of the frozen fried rice.

By performing the stages described above, the method for manufacturing Kkakdugi fried rice according to the embodiments of the present invention may be conducted, and Kkakdugi fried rice may be defrosted and then heated to be eaten as a meal replacement. The unique texture and flavor of aged Kkakdugi, fried confectionery and pollack roe are harmonized with rice and vegetables to enhance the flavor of the Kkakdugi fried rice according to the embodiments of the present invention.

The above detailed description illustrates the present invention.

In addition, the above description describes preferred embodiments of the present invention, and the present invention may be used in various other combinations, changes and environments. That is, changes or modifications may be made within the scope of the concept of the invention described in the present specification, the scope of the above description and/or the scope of the technology or knowledge in the technical field. The above embodiments describe the best state for implementing the technical idea of the present invention, and a variety of changes required for its specific application and use may be made. Therefore, the detailed description of the invention is not intended to limit the present invention to the embodiments described above. Also, the scope of the claims as attached shall be construed to include other embodiments.

1. A method for manufacturing Kkakdugi fried rice, comprising:
a washing stage of washing prepared mixed rice;
a first preparation stage of chopping vegetables;
a rice-cooking stage of mixing the washed mixed rice with rice-cooking water and heating a mixture of the washed mixed rice and the rice-cooking water to perform rice-cooking;
a second preparation stage of cutting seasoned Kkakdugi in a predetermined form and steaming the cut seasoned Kkakdugi through a steaming process with steam and then immersing the steamed Kkakdugi in a seasoning solution for 2 to 3 hrs; and
a cooking stage of heating and mixing the cooked mixed rice with the chopped vegetables, immersed Kkakdugi, subsidiary ingredients and oils through a stirring process to cook fried rice, the subsidiary ingredients comprising fried confectionery, pollack roe and purified water,
wherein the mixed rice comprises white rice, brown rice and black rice in a weight ratio of 1:0.1 to 0.3:0.3 to 0.5,
wherein the steaming process comprises steaming the cut seasoned Kkakdugi at 100° C. to 120° C. for 1 to 5 minutes,
wherein the seasoning solution comprises glycine, saline, red pepper powder, dental pigment, sodium L-glutamic acid, saccharin and purified water.

2. The method for manufacturing Kkakdugi fried rice according to claim 1,
wherein, in the first preparation stage, the vegetables comprise 30 to 50 wt % of potatoes, 20 to 40 wt % of carrots and 20 to 40 wt % of shiitake mushrooms, based on 100 wt % of the vegetables, and
wherein, in the cooking stage, the fried rice comprises 40 to 60 wt % of washed mixed rice, 20 to 40 wt % of aged Kkakdugi, 7 to 13 wt % of chopped vegetables, 6.1 to 11.5 wt % of subsidiary ingredients and 0.6 to 4.5 wt % of oils, based on 100 wt % of the fried rice.

3. The method for manufacturing Kkakdugi fried rice according to claim 2,
wherein the subsidiary ingredients comprise the fried confectionery, pollack roe and purified water in a weight ratio of 1:6:10, and
wherein the oils comprises sunflower seed oil, perilla oil and sesame oil in a weight ratio of 1:1:1.
